(19) United States
(12) Patent Application Publication
(10) Pub. No.: US 2001/0033071 A1
(43) Pub. Date: Oct. 25, 2001

(54) Snowmobile caddy

(76) Inventor: Derek W. Krumwiede, Cissna Park, IL (US)

Correspondence Address: Richard C. Litman, LITMAN LAW OFFICES, LTD., P.O. Box 15035, Arlington, VA, 22215, US

(21) Appl. No.: 09/784,120

(22) Filed: Feb. 16, 2001

Related U.S. Application Data
(60) Provisional application No. 60/186,755, filed on Mar. 3, 2000.

(51) Int. Cl. B60P 3/06

(52) U.S. Cl. 280/656; 280/414.1

(57) ABSTRACT

An adjustable snowmobile caddy consisting of a telescoping frame set atop four wheels. The frame comprises a plurality of square steel tubing cross bars which are parallel to each other, and two square steel tubing horizontally opposed support members which are parallel to one another, wherein the cross bars are attached to the two horizontal support members like rungs on a ladder. The adjustable snowmobile caddy is designed to permit a single individual to drive and store a snowmobile on the caddy without assistance. The snowmobile caddy can also be easily and conveniently moved around a garage or other area with a flat surface.

### CROSS-REFERENCE TO RELATED APPLICATION

This application claims the benefit of U.S. Provisional Patent Application Ser. No. 60/186,755, filed Mar. 3, 2000.

### BACKGROUND OF THE INVENTION

1. Field of the Invention

The present invention generally relates to snowmobiles. More specifically, the invention is a snowmobile support caddy for movably supporting or transporting snowmobiles.

2. Description of Related Art

Snowmobiles are frequently stored in garages and there is a need to be able to move the snowmobile around without having to start the snowmobile. Many devices have been designed in an effort to address this need but they tend to require more than one person to place the snowmobile on the storage or transporting apparatus. These previously known devices also tend to require a substantial amount of storage space, are not compact, and are difficult to construct and disassemble.

U.S. Pat. No. 3,860,078 issued to Stoick on Jan. 14, 1975 shows a snowmobile support apparatus comprising a support dolly for lifting and supporting the rear end of a snowmobile. The Stoick snowmobile support apparatus also requires a separate dolly to support the front of the snowmobile. Because two dollies are required to support the snowmobile, one person could not place a snowmobile on both dollies conveniently.

U.S. Pat. No. 5,441,378 issued to Puls on Aug. 15, 1995 discloses a snowmobile lift dolly that includes a support frame on three casters and a lifting mechanism to lift and support the skies of the snowmobile. A second support frame must be utilized for the rear end of the snowmobile. The snowmobile lift dolly of Puls only supports the front of the snowmobile. While the rear end of the snowmobile must be dealt with separately. This dolly is not very convenient; does not support the entire snowmobile; and makes maneuvering the snowmobile while located on the dolly difficult.

U.S. Pat. No. 5,632,498 issued to Beaudet et al. on May 27, 1997 describes a three-piece snowmobile dolly system consisting of one piece for supporting the rear end of the snowmobile, and two identical pieces for supporting each of the skies located on the front of the snowmobile. However, two or more people are needed to get the snowmobile onto the three dollies taught by Beaudet, wherein the snowmobile operator must maneuver the skies onto the two dollies, while another individual maneuvers the third dolly under the rear end of the snowmobile.

U.S. Pat. No. 3,881,740 issued to Johnson et al. on May 6, 1975 describes a wheeled snowmobile storage pallet. The pallet of Johnson is a generally T-shaped fixed dimensioned structure with four caster wheels. Johnson's pallet is neither adjustable nor dismantleable for compact storage, and does not fit any size snowmobile.

U.S. Pat. No. 3,897,959 issued to Haffner on Aug. 5, 1975 discloses a snowmobile dolly which has a two-frame structure that includes a ramp, a means for supporting snowmobile tracks and caster wheel assemblies. The Haffner snowmobile dolly is neither adjustable nor dismantleable for compact storage, and does not fit snowmobiles of varying sizes.

U.S. Pat. No. 4,288,087 issued to Morrison on Sep. 8, 1981 shows a snowmobile support dolly which has a pair of two-wheeled H-frame dollies and a caster wheeled H-framed track dolly for supporting the steering skis and drive track, respectively, of the snowmobile. The dolly of Morrison has three wheels, one which is a pivotable caster wheel assembly. However, a three-wheel dolly is not as sturdy as a four-wheel support apparatus. Also, the dolly taught in Morrison cannot be easily disassembled and stored, and is not adjustable for supporting snowmobiles of varying sizes.

None of the above inventions and patents, taken either singly or in combination, is seen to describe the instant invention as claimed.

### SUMMARY OF THE INVENTION

The adjustable snowmobile caddy according to the invention is designed to permit a snowmobile to be driven onto the caddy and thereafter conveniently moved in a garage or other area having a substantially flat surface. The snowmobile caddy is easily maneuvered when in use, and can be readily disassembled and stored when not in use. A single individual can place a snowmobile on the snowmobile caddy without assistance.

The snowmobile caddy is constructed of all steel tubing, preferably telescoping steel tubing, which makes the snowmobile caddy adjustable to fit snowmobiles of various sizes. The snowmobile caddy is also easily dismantled for compact storage. In a preferred embodiment the snowmobile caddy comprises a foot break to prevent the snowmobile from rolling away. A snowmobile may be easily driven onto and off of the snowmobile caddy, thus making it possible for a single person to utilize the caddy.

The snowmobile caddy has four 3″ steel caster wheels which are very sturdy, and make it very easy to move a snowmobile on the snowmobile caddy around in a garage. The apparatus of this invention permits one person to move the snowmobile around without difficulty. Also, the design of the snowmobile caddy keeps the skids of the snowmobile from scratching any surfaces because there is no need to scoot the snowmobile around.

Accordingly, it is a principal object of the invention to provide an easy and convenient means for moving and storing a snowmobile.

It is another object of the invention to provide a snowmobile caddy that can be easily constructed and dismantled by one person.

It is a further object of the invention to have a snowmobile caddy that permits one person to place the snowmobile on the snowmobile caddy.

Still another object of the invention is to provide a snowmobile caddy that can be easily stored without taking up a lot of excess space.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental view of a snowmobile caddy according to the present invention, and a snowmobile that can be fully supported thereon.

FIG. 2 is an elevated view of a snowmobile caddy according to the present invention.

FIG. 3 is a closeup view of a front skid on the snowmobile caddy partially broken away according to the present invention.

FIG. 4 is a closeup view of a rear wheel and break assembly on the snowmobile caddy partially broken away according to the present invention.

Similar reference characters denote corresponding features consistently throughout the attached drawings.

### DETAILED DESCRIPTION OF THE PREFERRED EMBODIMENT

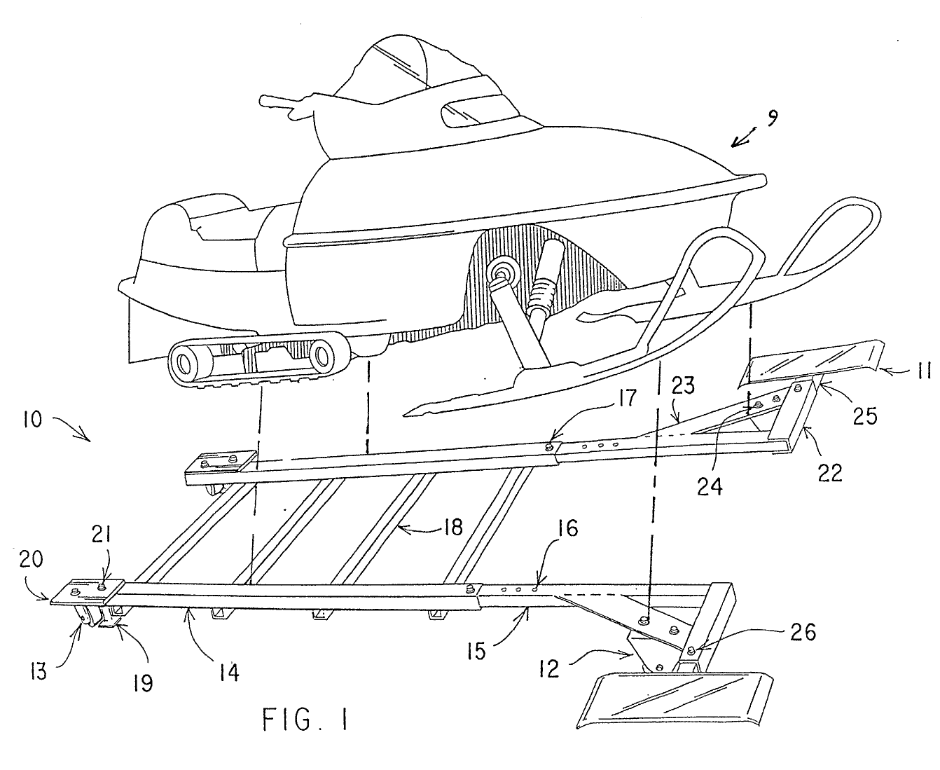

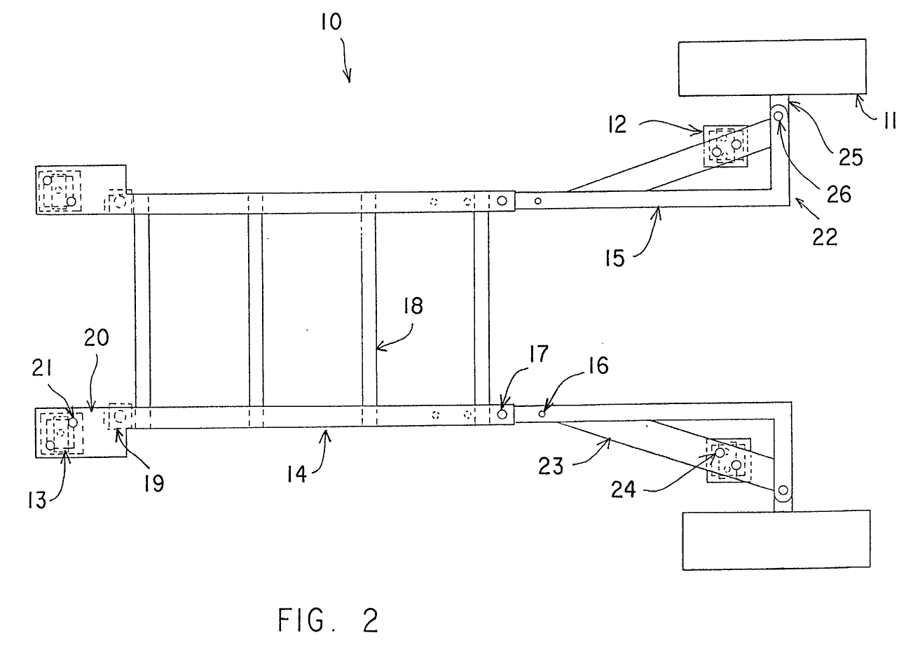

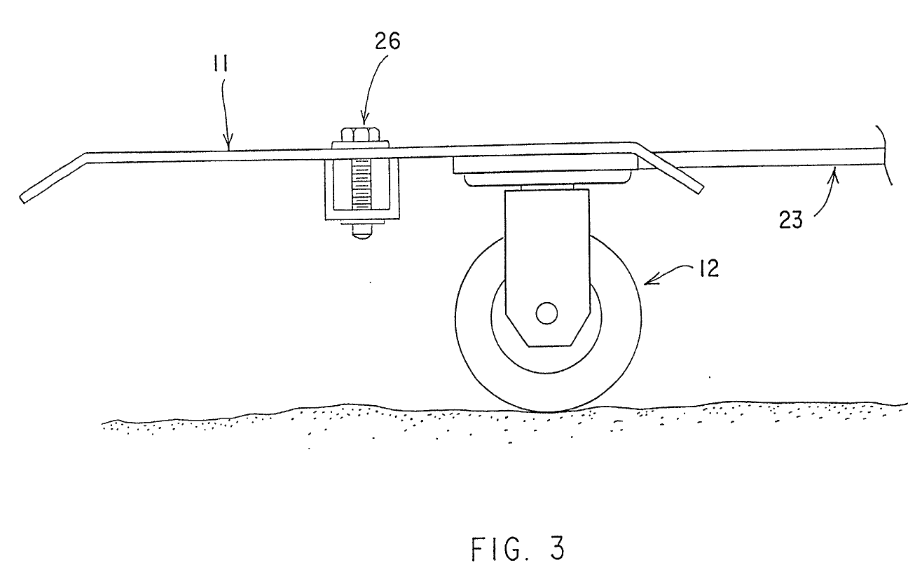

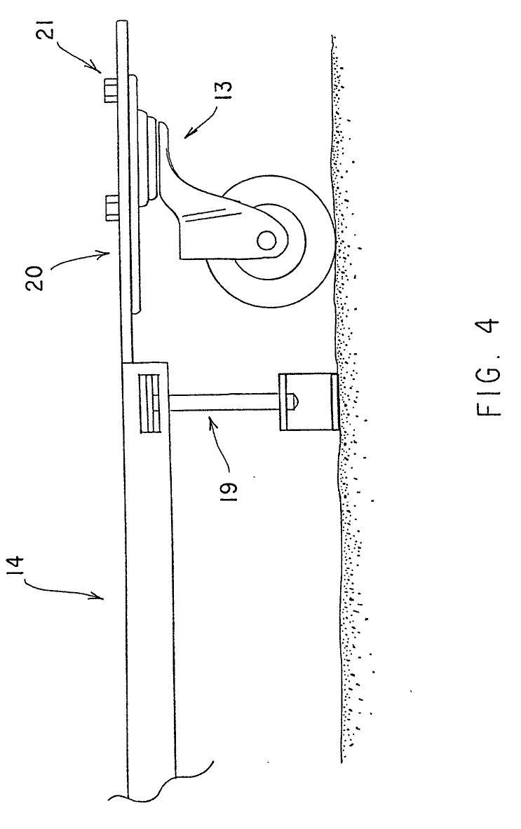

The present is directed to an adjustable snowmobile caddy for moving, transporting, and storing a snowmobile in a garage or similar enclosure. The preferred embodiment of the invention is depicted in FIGS. 1 and 2, and is generally referenced numeral 10. Elemental features are separately referenced and depicted in FIGS. 3 and 4.

As shown in FIG. 1, the invention comprises an adjustable snowmobile caddy 10 for moving, transporting, and storing a snowmobile 9 in a garage or other flat surface. While various apparatus for moving and storing a snowmobile have been developed in the past, the present snowmobile caddy 10 has an all-in-one adjustable structure that will fit snowmobiles of different sizes and models, and can be used by a single individual.

As shown in FIG. 2, the snowmobile caddy 10 contains a frame that is made up of a plurality of cross bars 18 which are parallel to each other and two hollow horizontally opposed support members 14 which are parallel to one another. The cross bars 18 are attached to the two horizontal support members 14 in a ladder-like manner with the cross bars 18 being the rungs. In the preferred embodiment, there are four cross bars 18 made from 1″ square steel tubing welded to the two parallel horizontally opposed support members 14 at ¾″, 12½″, 24″ and 35″ from the back of the horizontal support members 14. Each horizontal support member 14 is made of 1½″ square steel tubing that is 45″ long.

As shown in FIG. 4, located at the back or rear end of each horizontal support member 14 there is a means to attach a rotatable caster 13 to the horizontal support member 14. A preferred means for attaching the rotatable caster 13 is via a flat plate 20 attached to the horizontal support member 14, wherein the casters are attached to the flat plate 20 by screws 21 or other such fastening means. The rotatable casters 13 can be conventional ones well known in the art. More preferably, the flat plate 20 is a piece of steel that is 3/16″by 3½″ by 6¼″ in dimensions. Also attached to the rear ends of the horizontal support members 14 are breaking means 19 adjacent to each of the flat plates 20.

At the front of the horizontal support members 14, there are means for telescopically receiving extension support members 15. The extension support members 15 have a plurality of holes 16 that can be inserted into the hollow ends of the horizontal support members 14 and fixed into place by at least one screw 17 per extension support member 15. Preferably, each extension support member 15 is made of a 40″ long piece of 1¼″ square steel tubing. As best shown in FIGS. 1-2, attached to the end opposite to the holes 16 of each extension support member 15 is a ski support member 22 attached perpendicularly to the extension support member 15. In the preferred embodiment, the ski support member 22 is made of a 10″ piece of 1½″ square steel tubing which is welded to the end of the extension support member 15.

The snowmobile caddy 10 has two diagonal support members 23, each of which is attached to an extension support 15 and a ski support member 22. Preferably, each diagonal support member 23 is made of a 3/16″ by 3″ piece of steel. Attached to each diagonal support member 23 is a straight caster 12. The straight casters 12 are held in place by screws 24.

Telescopically attached to each ski support member 22 is a ski support extension member 25 which is inserted into the ski support member 22 as shown in FIGS. 1-3. The ski support members 22 and the ski support extension members 25 are each held together by screws 26. The ski support extension members 25 are each 14″ long and 1¼″ square steel tubing. Perpendicularly attached to each ski support extension member 25 is a ski support pad 11 for supporting the skis of the snowmobile. Optimally, the ski support pad 11 is 15″ long and 4½″ wide. At each end of the ski support pad 11, there is an approximately 30° bend 1″ from the edge of each pad, wherein the bend is directed downwards, away from the snowmobile to be stored on the snowmobile caddy 10.

It is to be understood that the present invention is not limited to the sole embodiment described above, but encompasses any and all embodiments within the scope of the following claims.

I claim:

1. A snowmobile caddy for moving and storing a snowmobile, said snowmobile caddy comprising:
two horizontal support members running parallel to one another, each horizontal support member having a front part containing at least one hole and a back part;
a plurality of cross bars attached at each end to said horizontal support members in a ladder-like manner;
two flat plates attached to the back part of each said horizontal support members;
two rotatable castors attached to said flat plates;
breaking means attached to the back part of said horizontal support members;
two extension support members having a front part and a back part, the back part of said extension support members telescopically engaged to the front part of said horizontal support members, and the front part of said horizontal support members having a plurality of holes;
means for telescopically locking said extension support members and said horizontal support members in place lengthwise;
two ski support members attached to the front part of said extension support members;
two diagonal support members attached to near the front part of said extension support members and to said ski support members;
two straight castors attached to said diagonal support members;
two ski support extension members telescopically engaged with said ski support members;
means for locking telescoping said ski support extension members and said ski support members in place; and
two ski support pads attached to said ski support extension members.

2. The snowmobile caddy according to claim 1, wherein said means for telescopically locking said extension support members and said horizontal support members in place lengthwise includes a bolt.

3. The snowmobile caddy according to claim 1, wherein said means for locking telescoping said ski support extension members and said ski support members in place includes a bolt.

4. A snowmobile caddy for moving and storing a snowmobile, said snowmobile caddy comprising, in combination with a snowmobile:
two horizontal support members running parallel to one another, each horizontal support member having a front part containing at least one hole and a back part;
a plurality of cross bars attached at each end to said horizontal support members in a ladder-like manner;
two flat plates attached to the back part of each said horizontal support members;
two rotatable castors attached to said flat plates;
breaking means attached to the back part of said horizontal support members;
two extension support members having a front part and a back part, the back part of said extension support members telescopically engaged to the front part of said horizontal support members, and the front part of said horizontal support members having a plurality of holes;
means for telescopically locking said extension support members and said horizontal support members in place lengthwise;
two ski support members attached to the front part of said extension support members;
two diagonal support members attached to near the front part of said extension support members and to said ski support members;
two straight castors attached to said diagonal support members;
two ski support extension members telescopically engaged with said ski support members;
means for locking telescoping said ski support extension members and said ski support members in place; and
two ski support pads attached to said ski support extension members. 5. The snowmobile caddy according to claim 4, wherein said means for telescopically locking said extension support members and said horizontal support members in place lengthwise includes a bolt. 6. The snowmobile caddy according to claim 4, wherein said means for locking telescoping said ski support extension members and said ski support members in place includes a bolt. 7. The snowmobile caddy according to claim 4, wherein the caddy is made of a material impervious to rust and corrosion.
